(19) United States
(12) Patent Application Publication
(10) Pub. No.: US 2026/0016320 A1
(43) Pub. Date: Jan. 15, 2026

(54) Sensor Module and System

(71) Applicant: SVM Schultz Verwaltungs-GmbH & Co. KG, Memmingen (DE)

(72) Inventors: Robin Gruber, Benningen (DE); Ralph Wassermann, Holzgünz (DE)

(21) Appl. No.: 19/263,835

(22) Filed: Jul. 9, 2025

(30) Foreign Application Priority Data
Jul. 9, 2024 (DE) 102024119484.7

(51) Int. Cl. G01D 5/14

(52) U.S. Cl. CPC G01D 5/145

(57) ABSTRACT

A sensor module includes a sensor housing, a Hall sensor, a magnet, and a movement transmission device which protrudes from the sensor housing. The Hall sensor or the magnet is attached to the movement transmission device for joint movement and another of the Hall sensor or magnet is arranged in a stationary manner relative to the sensor housing.

### CROSS-REFERENCE TO RELATED APPLICATIONS

This non-provisional application claims the benefit of, and priority to, German Application No. 102024119484.7, filed on Jul. 9, 2024, which is incorporated by reference in its entirety.

### FIELD OF THE DISCLOSURE

The present disclosure relates to a sensor module and a system containing the sensor module.

### BACKGROUND

Hall sensors are known. Electromagnets that sense the armature stroke position using a Hall sensor are also known. However, Hall sensors typically require a large amount of installation space, in particular when integrated in the housing of the electromagnet. Furthermore, such Hall sensors are costly to develop since they constitute specific solutions. In addition, Hall sensors installed in this way can usually only be handled in a complicated manner during assembly. In addition, known Hall sensors may have distances between the sensor and the target due to installation space conditions, which lead to insufficient resolutions.

### SUMMARY

A sensor module can include: a sensor housing; a Hall sensor; a magnet; and a movement transmission device which protrudes from the sensor housing, wherein the Hall sensor or the magnet is attached to the movement transmission device for joint movement and another of the Hall sensor or magnet is arranged in a stationary manner relative to the sensor housing.

A system can include: a sensor module; and an electromagnet with an electromagnet housing, wherein the sensor housing is arranged on an end face of the electromagnet housing, and wherein the movement transmission device protrudes into the electromagnet housing.

### BRIEF DESCRIPTION OF THE DRAWINGS

Further features, details, and advantages of the invention are apparent from the wording of the claims and also from the description below of exemplary embodiments with reference to the drawings, in which:

FIG. 1 shows a longitudinal sectional view through a system in a first state, and

FIG. 2 shows a longitudinal sectional view through the system in a second state.

### DETAILED DESCRIPTION

In the figures, identical or mutually corresponding elements are each denoted by the same reference signs and therefore, if not expedient, are not described again. In order to avoid repetition, features that have already been described will not be described again, and such features are applicable to all elements with the same or mutually corresponding reference signs unless this is explicitly ruled out. The disclosures in the description as a whole are transferable analogously to identical parts with the same reference signs or the same component designations. It is also the case that the positional indications chosen in the description, such as at the top, at the bottom, at the side, etc., relate to the figure illustrated and presently being described and, in the case of a position being changed, are to be transferred analogously to the new position. Furthermore, it is also possible for individual features or combinations of features from the different exemplary embodiments shown and described to constitute independent inventive solutions or solutions according to the invention.

Disclosed is a sensor module comprising a sensor housing, a Hall sensor and a magnet, and a movement transmission device which protrudes from the sensor housing, wherein the Hall sensor or the magnet is attached to the movement transmission device for joint movement and the other of the Hall sensor and magnet is arranged in a stationary manner relative to the sensor housing.

Due to its own sensor housing, there is no need to integrate the sensor module in another housing of the component to be sensed, for example in an electromagnet housing. A movement and/or position of the component to be sensed can be transmitted in a simple manner by way of the movement transmission device into the sensor housing to the Hall sensor. The sensor module enables very precise position detection in a high resolution quality by virtue of a close arrangement of the Hall sensor and magnet in the sensor housing. In addition, the sensor module can be understood as meaning a structural unit, which significantly reduces assembly costs. Since the sensor module can also be arranged outside another housing, the sensor system is no longer limited by installation space restrictions within the housing. In addition, the sensor module avoids extensive verification and construction effort, since it only needs to be constructed and verified once in order to be used in a versatile manner afterwards.

This provides a universal and compact sensor module which can be easily attached to the outside of another housing (for example to an electromagnet) and can evaluate the movement and/or position of the component to be sensed (for example an armature stroke position) very accurately.

The advantages of the sensor module are evident in particular in combination with an electromagnet. The compact sensor module can be attached to the electromagnet housing like a rucksack in order to pick up the position of the armature from the outside using the movement transmission device. In addition, the sensor module offers little construction effort and little adaptation effort due to its own scalability.

The magnet can be a permanent magnet. The magnet is the sensor target of the Hall sensor. The Hall sensor and the magnet are arranged in the sensor housing, preferably in any operating position. The Hall sensor and the magnet are arranged movably relative to each other.

According to one development, the movement transmission device can be a coupling rod. Advantageously, only a single component is therefore required for movement transmission. In addition, a rod can be very easily scaled in length and/or diameter. A rod can also protrude deep into another housing in order to pick up a movement there.

According to one development, the movement transmission device may carry the Hall sensor or the magnet on one end and on the other end may have a movement introduction surface, preferably on its end face. A movement force can be introduced into the movement transmission device via the movement introduction surface. Therefore, the movement transmission device must only be exactly as large as necessary. In embodiments, the movement introduction surface is a contact surface. Another component may rest on the contact surface without a connection. No connection advantageously needs to be established in order to introduce a movement force.

According to one development, the movement transmission device can be an injection-moulded part which comprises the magnet as an insert. Preferably, the movement transmission device is injected around the magnet. This allows the component to be manufactured in an off-tool and simple manner. A loosening or relative movement of the movement transmission device and magnet is prevented. The movement transmission device can be a plastic injection-moulded part (thermoplastic or thermoset). This is associated with a low weight. The magnet from the sensor/magnet pair can also advantageously be an insert, since it does not require any electrical contacts.

According to one development, the movement transmission device may have a longitudinal guide device and/or rotation prevention device on the sensor module side. The longitudinal guide device is used to control and guide the movement transmission device in its longitudinal direction. The rotation prevention device prevents rotation of the movement transmission device around its longitudinal axis. This makes it possible to carry out permanently high-quality sensing.

According to one development, the Hall sensor and the magnet may be arranged within the sensor housing, preferably over a complete adjustment travel of the movement transmission device. This underlines the compact and modular design and prevents external influences on the sensor/magnet pair.

According to one development, the sensor housing may be formed in one piece, may preferably be an injection-moulded part, and the Hall sensor or the magnet may preferably be an insert of the sensor housing. The overmoulded component is then an insert. If the magnet is already an insert in the movement transmission device, only the Hall sensor can be an insert in the sensor housing. The sensor housing can be a plastic injection-moulded part (thermoplastic or thermoset). This is associated with a low weight. The magnet from the sensor/magnet pair can also advantageously be an insert, since it does not require any electrical contacts.

According to one development, the sensor housing may be bottomless, and may preferably be an electromagnet housing cover. Since the sensor module is suitable for being arranged on the outside of a housing or with another housing, it can use the other housing (e.g. electromagnet housing) to close its own interior space. Therefore, the sensor housing as such can be without a bottom. The sensor housing itself can advantageously be a cover of an electromagnet housing. Thus, further weight can be saved by the fact that the electromagnet housing is open at one end and the sensor housing is open at the bottom, with the result that both in combination close an interior space (e.g. armature space).

In embodiments, the sensor housing comprises an annular disc section and a blind hole section. This reduces a need for installation space, since the annular disc section can be flat and the blind hole section forms an interior space for accommodating the Hall sensor, magnet, and movement transmission device. The Hall sensor and/or magnet and/or movement transmission device (the latter at least partially) may be arranged in the blind hole section.

In embodiments, the sensor housing forms ribs running in the radial direction. The reference can be the longitudinal axis of the movement transmission device. The ribs are used to stiffen the sensor housing. This allows it to be connected to another housing in a pressure-tight manner, thus withstanding an internal pressure. This is especially true if the sensor housing closes an interior space of an electromagnet in a pressure-tight manner.

According to one development, the sensor housing can carry an electrical contact of the sensor module and/or can carry an electrical contact of an electromagnet. The contact can be an insert. This results in functional integration in the sensor housing in order to optimize installation space. In embodiments, the sensor housing is formed in one piece with a control box. The control box may contain electronic components of the sensor module and/or of an electromagnet. This also results in functional integration in the sensor housing in order to optimize installation space.

According to one development, the sensor housing can form attachment points for attachment to another housing. This reduces a construction and adaptation effort, since only the attachment points of the sensor housing need to be adapted to the respective other housing for attachment. The other housing is a separate housing from the sensor housing.

According to one development, it is possible to provide a preloading device which preloads the movement transmission device in one direction, preferably in a direction facing away from the sensor module. The preloading device can preload the movement transmission device in the direction of the armature. This ensures interaction in every operating state. The preloading device can be a compression spring. The preloading device ensures a defined position against that component whose movement is intended to be picked up. Therefore, the movement transmission device and the component to be sensed do not need to be attached to each other either. The preloading device is also used for tolerance compensation. The preloading device can be arranged in a receiving pot formed by the movement transmission device, in which case this has a simple construction and saves installation space. The preloading device can be supported at one end on the sensor housing and at the other end on the movement transmission device, preferably in the receiving pot.

According to one development, the movement transmission device can rest loosely against a component to be sensed via its movement introduction surface. Since a fixed connection is now no longer required, assembly effort is considerably reduced and failure of a fixed connection is avoided from the outset.

According to one development, the sensor module can be an assembly. It may be assembled in a self-contained manner. It can then be attached to another housing. This reduces assembly effort, since the sensor module can be manufactured separately and independently.

According to one development, the sensor housing may have an annular recess in which a core of an electromagnet can be attached. This allows the sensor module and the electromagnet to reduce a need for installation space.

Also disclosed is a system comprising a sensor module according to the disclosure and an electromagnet with an electromagnet housing, wherein the sensor housing is arranged on the end face of the electromagnet housing and the movement transmission device protrudes into the electromagnet housing. This allows the movement of the armature to be picked up from outside the electromagnet housing in a very simple and high-quality manner. The Hall sensor and the magnet are arranged outside the electromagnet housing. The movement transmission device rests on the armature. The sensor housing may be crimped to the electromagnet housing. If the electromagnet housing has plastic components, it can alternatively be ultrasonically and laser welded, or hot-stamped. An end-face edge of the electromagnet housing can encircle the sensor housing, preferably the annular disc section, in a crimped manner on the outer circumference. The other housing may be the electromagnet housing. The electromagnet housing and the sensor housing are separate housings from each other.

According to one development, the movement transmission device can protrude through a through-hole in the core and can protrude into an armature space, in which case its outer diameter in the region of the core is greater than or equal to that in the region of the armature space. The movement transmission device can be used to guide the armature spring.

According to one development, the movement transmission device can form a travel limiter stop. The travel limiter stop can strike the core. It is used to limit the actuating movement and prevents uncontrolled slipping into the electromagnet. The travel limiter stop may be formed by a wall of a receiving pot for the preloading device.

An electromagnet according to the disclosure which is configured to be connected to the sensor module according to the disclosure is also contemplated.

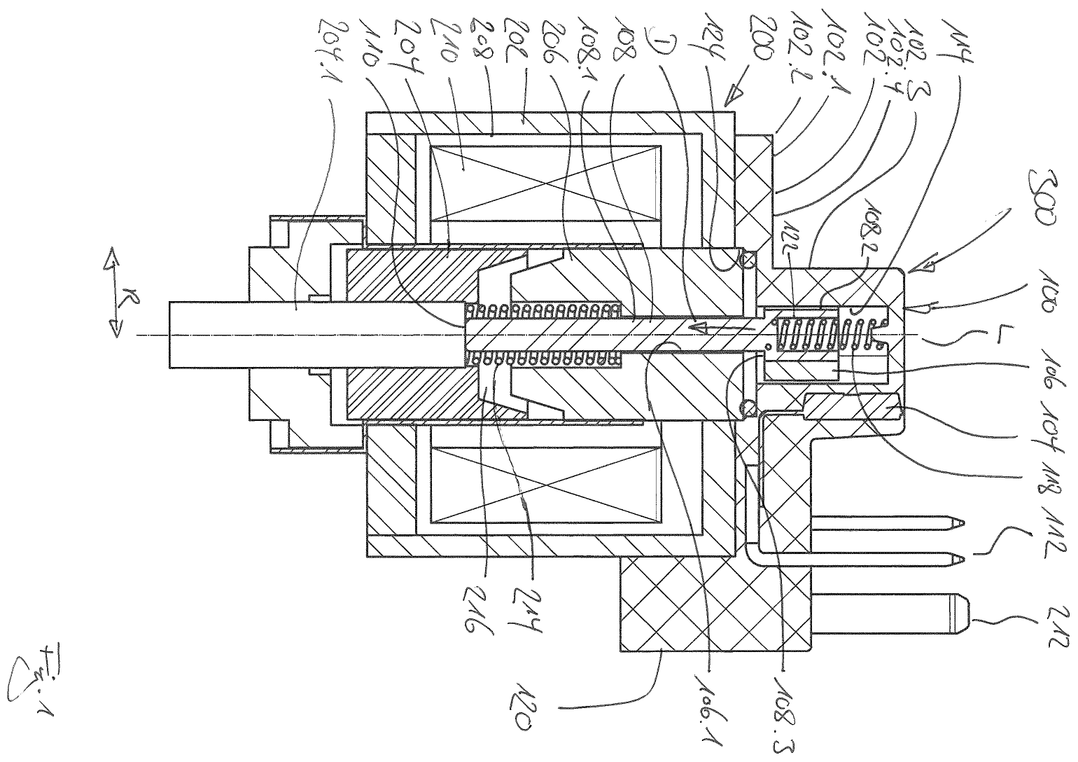

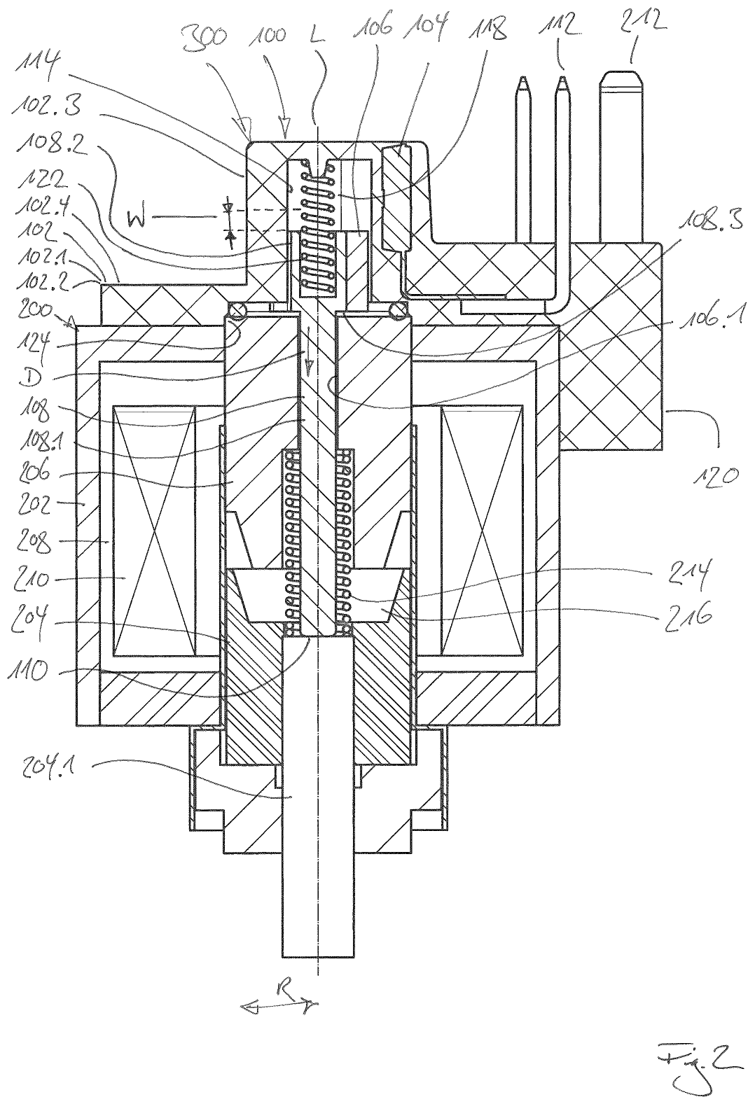

FIGS. 1 and 2 show a single system 300 comprising a sensor module 100 and an electromagnet 200. The system 300 is penetrated by a longitudinal axis L, with a radial direction R perpendicular to it.

The sensor module 100 comprises a one-piece sensor housing 102 formed as a plastic injection-moulded part. The sensor housing 102 is bottomless on the electromagnet side and forms an electromagnet housing cover 102.1 as a separate housing. The sensor housing 102 comprises an annular disc section 102.2 and a blind hole section 102.3, wherein the annular disc section 102.2 forms ribs 102.4 running in the radial direction R. The sensor housing 102 carries an electrical contact 112 of the sensor module 100 and an electrical contact 212 of the electromagnet 200. The sensor housing 102 is formed in one piece with a control box 120 which contains electronic components of the sensor module 100 and/or of the electromagnet 200. Furthermore, the sensor housing 102 forms a longitudinal guide device 114 in the form of a longitudinal rib in the blind hole section 102.3, which engages in a corresponding longitudinal groove 108.2 in a movement transmission device 108. The sensor housing 102 has an annular recess 124 in which a core 206 of the electromagnet 200 is attached.

The sensor module 100 also comprises a Hall sensor 104 which is arranged in a stationary manner relative to the sensor housing 102, since it is contained there as an insert. The Hall sensor 104 is located in the blind hole section 102.3.

The sensor module 100 further comprises a magnet 106 which is a permanent magnet and represents the sensor target for the Hall sensor 104. The magnet 106 is also located in the blind hole section 102.3, but is movable relative to the Hall sensor 104.

The sensor module 100 further comprises the movement transmission device 108 in the form of a coupling rod 108.1. The movement transmission device 108 is a plastic injection-moulded part, in which case the magnet 106 is an insert thereof. At one end, the movement transmission device 108 carries the magnet 106 and, at the opposite end along the longitudinal axis L, a movement introduction surface 110 is formed on the end face. The movement introduction surface 110 is a contact surface, since it rests without a connection and loosely on an armature 204 of the electromagnet 200. The movement transmission device 108 protrudes from the sensor housing 102 and into the electromagnet 200. The movement transmission device 108 forms a receiving pot 122 arranged in the blind hole section 102.3. The movement transmission device 108 forms a travel limiter stop 108.3.

The sensor module 100 also comprises a preloading device 118 in the form of a compression spring 118.1, which preloads the movement transmission device 108 in a direction D facing away from the sensor module 100. The preloading device 118 is arranged in the receiving pot 122 and is supported at one end on the sensor housing 102 and at the other end on the movement transmission device 108.

The electromagnet 200 comprises an electromagnet housing 202, in which an armature 204 with an armature rod 204.1 is movably mounted along the longitudinal axis L. Adjacent to this, the core 206 is arranged with its through-hole 206.1, through which the movement transmission device 108 protrudes. A coil carrier 208 carries a coil 210 which can be optionally energized for the purpose of adjusting the armature 204 along the adjustment travel W. An armature spring 214 is supported between the core 206 and the armature 204 for its exhibition. The armature 204 is located in an armature space 216.

The sensor housing 102 is arranged on the end face of the electromagnet housing 202 and closes an interior space of an electromagnet 200 in a pressure-tight manner. The Hall sensor 104 and the magnet 106 are arranged within the sensor housing 102 over the entire adjustment travel W. The Hall sensor 104 and the magnet 106 are arranged outside the electromagnet housing 202. The movement transmission device 108 has an outer diameter in the region of the core 206, which is greater than or equal to that in the region of the armature space 216. The travel limiter stop 108.3 can strike the core 206.

### LIST OF REFERENCE SIGNS

100 Sensor module
102 Sensor housing
102.1 Electromagnet housing cover
102.2 Annular disc section
102.3 Blind hole section
102.4 Rib
104 Hall sensor
106 Magnet
106.1 Through-hole
108 Movement transmission device
108.1 Coupling rod
108.2 Longitudinal groove
108.3 Travel limiter stop
110 Movement introduction surface
112 Contact
114 Longitudinal guide device
118 Preloading device
118.1 Compression spring
120 Control box
122 Receiving pot
200 Electromagnet
202 Electromagnet housing
204 Armature
204.1 Armature rod
206 Core
208 Coil carrier
210 Coil
212 Contact
214 Armature spring
216 Armature space
300 System
D Direction
L Longitudinal axis
R Radial direction
W Adjustment travel

The invention is not restricted to any one of the embodiments described above and instead can be modified in a wide variety of ways. All of the features and advantages apparent from the claims, the description, and the drawing, including structural details, spatial arrangements, and method steps, may be essential to the invention both individually and in a very wide variety of combinations.

The invention encompasses all combinations of at least two of the features disclosed in the description, the claims, and/or the figures.

To avoid repetition, features disclosed in relation to a device are also considered, and can be claimed, to be disclosed in relation to a method. It is likewise the case that features disclosed in relation to a method are considered, and can be claimed, to be disclosed in relation to a device.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A sensor module comprising:
a sensor housing;
a Hall sensor;
a magnet; and
a movement transmission device which protrudes from the sensor housing,
wherein the Hall sensor or the magnet is attached to the movement transmission device for joint movement and another of the Hall sensor or magnet is arranged in a stationary manner relative to the sensor housing.

2. The sensor module according to claim 1, wherein the movement transmission device is a coupling rod.

3. The sensor module according to claim 1, wherein an end of the movement transmission device carries the Hall sensor or the magnet and another end of the movement transmission device has a movement introduction surface.

4. The sensor module according to claim 3, wherein the movement introduction surface is on an end face of the movement transmission device.

5. The sensor module according to claim 1, wherein the movement transmission device is an injection-moulded part comprising the magnet as an insert.

6. The sensor module according to claim 1, wherein the Hall sensor and the magnet are arranged within the sensor housing.

7. The sensor module according to claim 6, wherein the Hall sensor and the magnet are arranged in the sensor housing over a complete adjustment travel of the movement transmission device.

8. The sensor module according to claim 1, wherein the sensor housing is formed in one piece.

9. The sensor module according to claim 8, wherein the sensor housing is formed from an injection-moulded part.

10. The sensor module according to claim 8, wherein the Hall sensor or the magnet is an insert of the sensor housing.

11. The sensor module according to claim 1, wherein the sensor housing is bottomless.

12. The sensor module according to claim 11, wherein the sensor housing is an electromagnet housing cover.

13. The sensor module according to claim 1, wherein the sensor housing carries an electrical contact of the sensor module and carries an electrical contact of an electromagnet.

14. The sensor module according to claim 1, wherein the sensor housing carries an electrical contact of the sensor module or wherein the sensor housing carries an electrical contact of an electromagnet.

15. The sensor module according to claim 1, wherein the sensor housing forms attachment points for attachment to another housing.

16. A system comprising:
a sensor module according to claim 1; and
an electromagnet with an electromagnet housing,
wherein the sensor housing is arranged on an end face of the electromagnet housing, wherein the movement transmission device protrudes into the electromagnet housing.
